(19) United States
(12) Patent Application Publication
(10) Pub. No.: US 2013/0022723 A1
(43) Pub. Date: Jan. 24, 2013

(54) COFFEE MAKING SYSTEMS AND ASSOCIATED METHODS

(71) Applicants: Lawrence D. Azzano, Seattle, WA (US); Kenneth J. Redding, Bellevue, WA (US); Doug E. Coppenbarger, Marysville, WA (US)

(72) Inventors: Lawrence D. Azzano, Seattle, WA (US); Kenneth J. Redding, Bellevue, WA (US); Doug E. Coppenbarger, Marysville, WA (US)

(21) Appl. No.: 13/554,832

(22) Filed: Jul. 20, 2012

Related U.S. Application Data
(60) Provisional application No. 61/510,411, filed on Jul. 21, 2011.

(51) Int. Cl. A47J 31/46; A23F 5/26

(52) U.S. Cl. 426/433; 99/283

(57) ABSTRACT

Systems and methods for providing coffee in varying amounts are disclosed herein. A coffee machine configured in accordance with one embodiment of the disclosure includes a coffee brewing unit that can brew a predetermined volume of coffee during a brewing cycle. A holding container can be configured to receive coffee from the brewing unit and a delivery valve can be positioned on a delivery tube extending from the holding container. The delivery valve can be operable from a closed position to an open position to dispense coffee, and one or more brewing cycles can be completed and delivered to the holding container prior to the coffee being dispensed.

### CROSS-REFERENCE TO RELATED APPLICATION(S)

This application claims the benefit of pending U.S. Provisional Patent Application No. 61/510,411, filed Jul. 21, 2011, and entitled COFFEE MAKING SYSTEMS AND ASSOCIATED METHODS, and which is incorporated herein by reference in its entirety.

### TECHNICAL FIELD

The present disclosure relates generally to systems and methods for brewing coffee and other hot beverages. More particularly, the systems and methods of the present disclosure are suitable for brewing coffee in an extended range of volumes.

### BACKGROUND

Coffee machines for use in homes, restaurants, and coffee shops are well known. Additionally, coffee machines that brew single servings on demand are also known. One type of single serving coffee machine employs a cylinder in communication with a single serving brewing chamber. A filter strip separates the brewing chamber from the cylinder and prevents coffee grounds from entering the cylinder. In a typical brewing cycle, a piston moves downwardly in the cylinder to suck coffee through the filter strip and into the cylinder. By providing single serving “on demand” coffee, this type of coffee machine prevents the coffee from becoming stale by remaining in a container for a lengthy period of time between brewing and delivery to the consumer. Additionally, the brewing method ensures that there is both sufficient extraction of coffee from the grounds and a rapid brew cycle.

Although single serving on demand coffee machines provide quality coffee, the size of the cylinder in the machines limits the volume they can supply in a single demand cycle. The cylinder size is often optimized to provide the best quality within a small range of the most common sizes. In order to provide more than the limited cylinder volume to a single user, the machine may have to operate for multiple brew cycles. This can lead to spills if a consumer inadvertently removes their receptacle before the demand cycle is finished. Accordingly, it is desirable to provide a coffee machine that can uniformly produce quality coffee in an extended range of volumes.

### BRIEF DESCRIPTION OF THE DRAWINGS

FIG. 1 is a partially schematic elevation view of a coffee machine configured in accordance with an embodiment of the present disclosure.

FIG. 2 is a partially schematic elevation view of a coffee machine configured in accordance another embodiment of the present disclosure.

### DETAILED DESCRIPTION

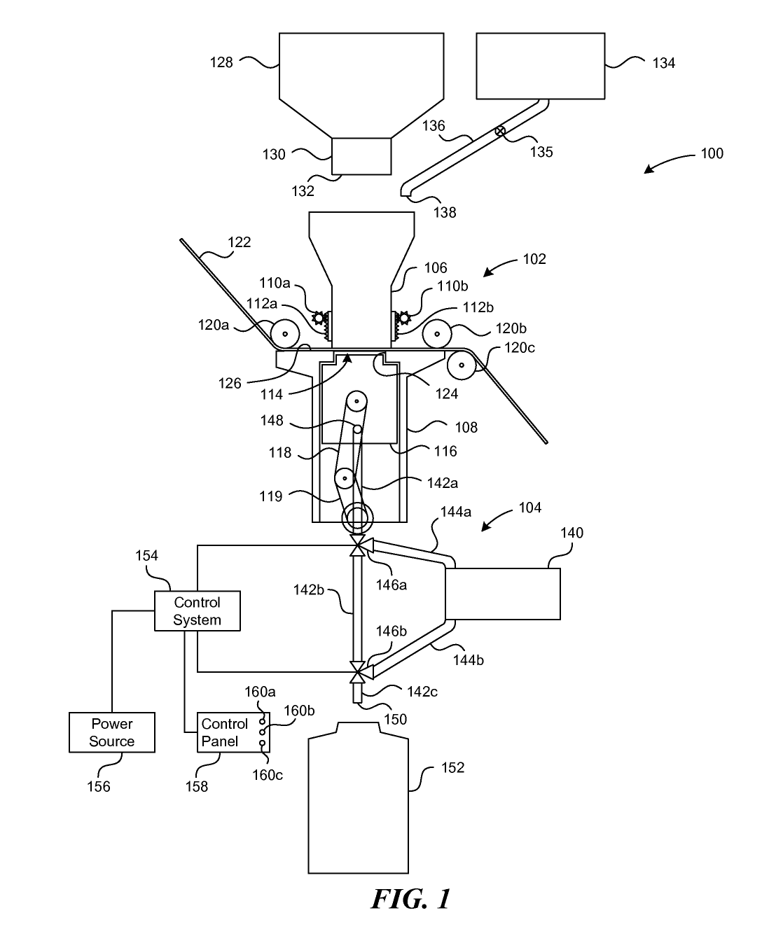

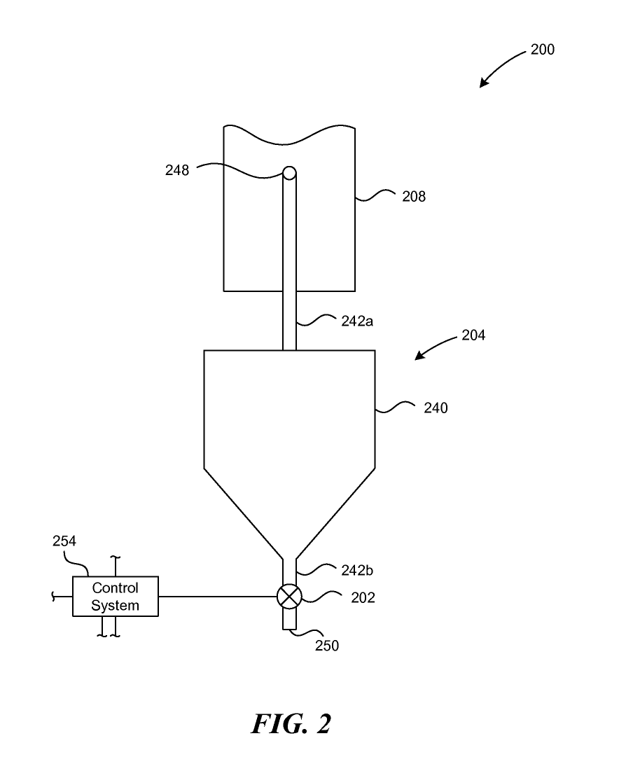

The following disclosure is directed generally to machines for brewing coffee and/or producing other brewed hot drinks, such as tea. Several details describing structures and processes that are well-known and often associated with coffee brewing machines are not set forth in the following description to avoid unnecessarily obscuring embodiments of the disclosure. Moreover, although the following disclosure sets forth several embodiments, several other embodiments can have different configurations, arrangements, and/or components than those described herein. In particular, other embodiments may have additional elements, and/or may lack one or more of the elements described below with reference to FIGS. 1 and 2.

In the Figures, identical reference numbers identify identical or at least generally similar elements. To facilitate the discussion of any particular element, the most significant digit or digits of any reference number refer to the Figure in which that element is first introduced. For example, element 108 is first introduced and discussed with reference to FIG. 1. Moreover, the various elements and features illustrated in the Figures may not be drawn to scale.

FIG. 1 is a partially schematic elevation view of a beverage brewing and dispensing machine 100 configured in accordance with an embodiment of the present disclosure. In the illustrated embodiment, the beverage brewing and dispensing machine 100, hereinafter referred to as the “coffee machine 100,” is a machine for brewing individually dispensed volumes of coffee. In other embodiments, however, the coffee machine 100 and suitable variations thereof can be used for making tea and other brewed beverages. Accordingly, while portions of the present disclosure may be directed to coffee machines, it should be understood that various embodiments of the machines and methods described herein can be used to produce other types of brewed beverages.

In the illustrated embodiment, the coffee machine 100 includes a brewing unit 102 and a delivery system 104. In some embodiments, the brewing unit 102 and aspects thereof may be substantially similar in structure and function to the brewing unit described in U.S. Pat. No. 3,522,976, the entirety of which is incorporated by reference herein. The brewing unit 102 includes a brewing chamber 106 and a base 108. The brewing chamber 106 is operably mounted above the base 108 and is movably coupled to a first pinion gear 110a and a second pinion gear 110b by a first rack 112a and a second rack 112b, respectively. The pinion gears 110 are operably coupled to drive shafts (not shown), and the drive shafts are operably coupled to a motor (also not shown).

In the illustrated embodiment, the base 108 includes a piston 116 reciprocatably disposed in a cylinder 114. The piston 116 is operably coupled to a connecting rod 118, and the connecting rod 118 is connected to a crankshaft 119, that is operably coupled to a motor (not shown). In some embodiments, the motor may be the same motor that is operably coupled to the drive shafts for the pinion gears 110. In other embodiments, there may be separate motors. A first roller 120a, a second roller 120b, and a third roller 120c are configured to direct a filter strip 122 along a top surface 126 of the base 108 between the brewing chamber 106 and an opening 124. The rollers 120a and 120b are operably coupled to spring biased shafts (not shown) to pull the filter strip 122 taut along the top surface 126. The third roller 126c is configured to direct the filter strip 122 toward an advancing wheel (not shown). The advancing wheel can be operably coupled to a motor, which in some embodiments may be the same motor that is coupled to the crankshaft 119 for the piston 116 and the drive shaft for the pinion gears 110. A filter spool (not shown) is configured to supply the filter paper 122.

The illustrated embodiment of FIG. 1 further includes a coffee bean hopper 128 with an attached grinder 130 having an outlet 132. A hot water container 134 includes an outlet tube 136 having a hot water valve 135 and a water outlet 138. The grinding outlet 132 and the water outlet 138 are positioned above the brewing chamber 106 to provide coffee grinds and hot water, as will be described in more detail below. Although the hopper 128 of the illustrated embodiment includes an attached grinder 130, other embodiments may not include a grinder 130, and the hopper 128 may be designed to contain previously ground coffee. In such embodiments, a dispensing mechanism would dispense the previously ground coffee into the brewing chamber 106.

The delivery system 104 of the illustrated embodiment includes a temporary storage container, or holding container 140, a first delivery conduit, such as a pipe or tube 142a, a second delivery tube 142b, a third delivery tube 142c, a first bypass tube 144a, and a second bypass tube 144b. A first bypass valve 146a is operably coupled to the first delivery tube 142a, the second delivery tube 142b and the first bypass tube 144a. A second bypass valve 146b is operably coupled to the second delivery tube 142b, the third delivery tube 142c and the second bypass tube 144b. The first delivery tube 142a is operably coupled to an opening 148 in the base 108 that extends inwardly into the cylinder 114. The third delivery tube 142c includes a delivery outlet 150 that is configured to be above a receptacle 152.

In the illustrated embodiment, the coffee machine 100 includes a control system 154 (shown schematically) that is operably coupled to the coffee grinder 130, the hot water valve 135, the bypass valves 146 and the previously discussed motor(s). The control system 154 can include a microprocessor, an integrated circuit board, computer readable medium storing operating instructions, and/or other electrical or computer components configured to control and operate the coffee machine 100 and known in the art. A power source 156 and an operator control panel 158 (also shown schematically) are operably coupled to the control system 154. The control panel 158 can include a first button 160a, a second button 160b, and a third button 160c. The buttons 160 are configured to enable a user to operate the coffee machine 100. Although the illustrated embodiment includes three buttons 160, other embodiments may include additional or fewer buttons and/or other user input devices (e.g., touch screens, etc.). Furthermore, in a commercial setting, the coffee machine 100 may include one or more slots for receiving money. The buttons 160 may be configured to provide different volumes of coffee. The first button 160a, for example, may be configured to provide 8 ounces of coffee, while the second button 160b may be configured to provide 16 ounces and the third button 160c may be configured to provide 24 ounces. In other embodiments, the buttons 160 may be configured to provide larger or smaller volumes and ranges of volumes of coffee.

Coffee brewing machines can be optimized to provide consistent flavorful coffee by using consistent amounts of coffee grounds and water in the correct ratio. This ratio varies based on several variables including the amount of brewing time, heat and pressure. Additionally, the thickness of the layer of grounds, the amount of mixing of the grounds with the water before filtering, and/or the volume of water that flows through an area of filter paper can all affect the flavor. Brewing units similar to the brewing unit 102 and having brewing chambers of approximately 8 to 12 ounces are known to provide high quality coffee. Although the size of the brew chamber and the cylinder may be increased to increase the volume, the consistency can be negatively affected if the brewing parameters are not properly changed to ensure similar brewing conditions. Additionally, increasing the chamber size to optimize for a larger brew size may require an increase in the overall size of the machine to fit the larger components. Furthermore, a machine optimized for the larger volume would no longer produce optimized results for a significantly smaller volume of water added to the brew chamber. The brewing chamber 106 and the cylinder 114 of the illustrated embodiment are sized to provide consistent quality coffee in volumes similar to existing machines. However, the delivery system 104 is configured to allow the delivery of larger volumes of coffee without sacrificing this quality.

In operation, a user selects a volume of coffee to be dispensed by pushing one of the buttons 160 on the control panel to initiate a demand cycle. If the buttons 160 are configured as discussed above, a user pushes the button 160a to initiate a demand cycle for e.g., 8 ounces of coffee, corresponding to a single brew cycle. The control system 154 operates the coffee grinder to grind coffee beans into coffee grounds that fall from the grinding outlet 132 into the brewing chamber 106 and are dispersed on the filter strip 122 within the brewing chamber 106. The control system 154 cycles the hot water valve 135 to dispense 8 ounces of hot water into the brew chamber 106. After a set amount of brewing time, the crankshaft 119 drives the piston 116 downward, pulling coffee through the filter strip 122 and into the cylinder 114. When the piston is below the outlet 148, the coffee flows out of the cylinder 114 and enters the first delivery tube 142a. The control system positions the first bypass valve 146a to direct the coffee to the second delivery tube 142b, and positions the second bypass valve 146b to direct the coffee to the third delivery tube 146c. The coffee flows through the delivery tubes 146, out the delivery outlet 150 and into the receptacle 152. The crankshaft 119 drives the piston 116 back into an upper position, and the drive shafts for the pinion gears cycle the brewing chamber 106 upwards. The advancing wheel advances the filter strip 122 and positions a clean portion of filter paper above the opening 124.

In another example, if a user desires 16 ounces of coffee, the user pushes the button 160b to initiate a demand cycle for 16 ounces, corresponding to a dual brew cycle. The coffee machine 100 operates similarly to above, but rather than positioning the bypass valves 146 to direct the coffee through the second delivery tube 142b, the control system 154 positions the bypass valves 146 to direct the coffee of the first brew cycle to the holding container 140. After completing the first brew cycle, the control system 154 initiates a second brew cycle and directs the additional coffee to the holding container 140. The control system 154 positions the second bypass valve 146b to direct the 16 ounces of coffee from the holding container 140 through the third delivery tube 142c. The coffee then flows out the delivery outlet 150 and into the receptacle 152 in one uninterrupted delivery. The control system 154 completes the second brew cycle by repositioning the piston 116 and advancing the filter strip 122 while cycling the brew chamber 106.

In yet another example, if a user desires 24 ounces of coffee, the user pushes the button 160c to initiate a demand cycle for 24 ounces, corresponding to a triple brew cycle. The coffee machine 100 operates similarly to above, but completes three brew cycles to produce and deliver 24 ounces of coffee in one uninterrupted delivery to complete the demand cycle. As can be seen from the above examples, the coffee machine 100 can provide an extended range of single serving volumes in an uninterrupted delivery.

The brewing cycle storage systems of the present disclosure may be used with virtually any existing coffee machine. The brewing cycle storage systems of the present disclosure, for example, may be incorporated into a Bravilor FreshGround coffee machine and/or similar machines available from Bravilor Bonamat (P.O. Box 188, 1700 AD, Heerhugowaard, The Netherlands). In this manner, a Bravilor coffee machine, or a coffee machine from another manufacturer, may be adapted to provide a larger range of coffee volumes in an uninterrupted delivery, without redesigning the brewing portion or developing a new machine.

FIG. 2 is a partially schematic plan view of a portion of a coffee machine 200 having a delivery system 204 configured in accordance another embodiment of the present disclosure. In the illustrated embodiment, the coffee machine 200 includes a base 208 having an opening 248. A first delivery tube 242a extends from the opening 248 to a holding container 240, and a second delivery tube 242b extends from an opposite end of the holding container 240 to a delivery outlet 250. A delivery valve 202 is operably coupled to the second delivery tube 242b and to a control system 254.

The delivery system 204 operates in a manner similar to the delivery system 104 discussed above. However, rather than controlling the bypass valves 146 to direct coffee to the holding container 140, the control system 254 maintains the delivery valve 202 in a closed position until the total volume of coffee to be delivered has been produced and dispensed into the holding container 240. When the desired number of brew cycles are complete, the control system 254 opens the delivery valve 202 to dispense the coffee into the user's cup.

From the foregoing it will be appreciated that specific embodiments of the invention have been described herein for purposes of illustration, but that various modifications may be made without deviating from the spirit and scope of the various embodiments of the invention. For example, the coffee machines disclosed herein can include differing sizes and shapes of holding containers and differing numbers of bypass or delivery valves. Additionally, differing volumes of coffee may be brewed in each brew cycle of any given demand cycle. For example, 4 ounces may be brewed in a first brew cycle and 8 ounces in a second. Furthermore, the operation of the valves and flow may be altered such that the coffee flows simultaneously from the cylinder 114 through the second bypass valve 146b and from the holding container 140 through the second bypass valve 146b. Moreover, while various advantages and features associated with certain embodiments have been described above in the context of those embodiments, other embodiments may also exhibit such advantages and/or features, and not all embodiments need necessarily exhibit such advantages and/or features to fall within the scope of the disclosure. Accordingly, the invention is not limited, except as by the appended claims.

I/we claim:

1. A coffee machine for providing varying amounts of coffee, the coffee machine comprising:
a coffee brewing unit configured to brew a first volume of coffee during a brewing cycle;
a holding container positioned to receive coffee from the coffee brewing unit;
a delivery tube extending from the holding container and positioned to dispense coffee;
a delivery valve operably coupled to the delivery tube and operable from a closed position to an open position to dispense coffee from the holding container; and
a controller operably coupled to the delivery valve and configured to operate the delivery valve from the closed position to the open position after a selected volume of coffee has been delivered to the holding container, wherein the selected volume of coffee is one of at least two available volumes of coffee, wherein the available volumes of coffee include the first volume of coffee and a second volume of coffee different than the first volume, and wherein the second volume of coffee is a multiple of the first volume of coffee.

2. The coffee machine of claim 1, further comprising means for selecting one of the available volumes of coffee, wherein the coffee machine performs two or more brewing cycles in response to a selection corresponding to the second volume of coffee.

3. The coffee machine of claim 1, further comprising an input device operably coupled to the controller and having input options that correspond to the available volumes of coffee, wherein a selection of the input option corresponding to the second volume of coffee directs the brewing unit to complete two or more brewing cycles to deliver the selected volume of coffee to the holding container.

4. The coffee machine of claim 1 wherein the coffee machine includes a payment receiving component configured to receive a payment from a consumer, and wherein the coffee machine is configured to confirm payment prior to initiating a brewing cycle.

5. A coffee machine for providing various volumes of coffee, the coffee machine comprising:
a brewing unit configured to complete at least one brewing cycle during a demand cycle, wherein the demand cycle corresponds to a selected volume of coffee, wherein the brewing cycle produces a predetermined volume of coffee, and wherein the selected volume of coffee corresponds to a multiple of the predetermined volume;
a holding container positioned to receive coffee from the brewing unit;
a delivery tube positioned to dispense coffee to a consumer;
a bypass valve operable between a first position that directs coffee from the brewing unit to the delivery tube via the holding container and a second position that directs coffee from the brewing unit to the delivery tube without passing through the holding container; and
a controller operably coupled to the bypass valve, wherein the controller is configured to operate the bypass valve to the first position in response to a selection of a demand cycle corresponding to two or more brewing cycles.

6. The coffee machine of claim 5 wherein the bypass valve is a first bypass valve, the coffee machine further comprising a second bypass valve positioned to receive coffee from the first bypass valve via a first flow path that includes the holding container and via a second flow path that does not include the holding container, and wherein the second bypass valve is operable between a first position that directs coffee to the delivery tube via the first flow path and a second position that directs coffee to the delivery tube via the second flow path.

7. A method for providing coffee in various volumes, the method comprising:
presenting at least two selectable volumes on a coffee machine;
in response to a selection of one of the selectable volumes, brewing a first volume of coffee during a first brewing cycle in a brewing unit;
directing the first volume of coffee to a holding container;
brewing a second volume of coffee during a second brewing cycle;
directing the second volume of coffee to the holding container; and
operating a valve to simultaneously dispense the first volume of coffee and the second volume of coffee through a delivery outlet.

8. The method of claim 7 wherein the valve is a first valve, and wherein directing the first volume of coffee to the holding container and directing the second volume of coffee to the holding container includes directing the first volume of coffee and the second volume of coffee through a second valve, and wherein the first valve and the second valve are operable to direct coffee from the brewing unit to the delivery outlet along a flow path that does not include the holding container.

9. The method of claim 7, further comprising receiving payment from a consumer via a payment device operably coupled to the coffee machine, wherein receiving payment occurs prior to brewing a first volume of coffee.
